(19) United States
(12) Patent Application Publication
(10) Pub. No.: US 2008/0167579 A1
(43) Pub. Date: Jul. 10, 2008

(54) Apparatus For Determining the Amount of Milk Breast-Fed to a Baby by Convective Heat Transfer

(76) Inventors: Lior Ben Ezra, Rishon Le-Zion (IL); Yoav Sella, Kefar-Sava (IL)

Correspondence Address: Sean Liam Kelleher;Kelleher & Lilling PLLC, P.O. BOX 560, GOLDEN BRIDGE, NY, 10526, US

(21) Appl. No.: 10/595,091

(22) PCT Filed: Aug. 12, 2004
(86) PCT No.: PCT/IB2004/003257

§ 371 Date: Feb. 7, 2006

(30) Foreign Application Priority Data
Aug. 12, 2003 (IL) 157354

(51) Int. Cl. A61B 5/00

(52) U.S. Cl. 600/584

(57) ABSTRACT

The apparatus for determining the amount of milk breast-fed to a baby by convection heat transfer includes a nipple shield, a tube and a thermal dilution gauge. On the nipple region of a mother, the nipple shield is mounted. Then, the tube is used to pass milk to the baby. The amount of milk passing through the tube is measured by the thermal dilution gauge.

### BACKGROUND OF THE INVENTION

1. Field of the Invention

This invention relates to baby care products and methods and more particularly to an apparatus to determine and monitor the volume of human milk breast fed by a nursing mother to a baby.

2. Description of the Related Art

Breast feeding is known as the best method of feeding a child in its first year of life. The benefits of breastfeeding can be both physical and psychological for both the mother and the child. Nutrients and antibodies are passed to the baby while hormones are released into the mother's system during breast feeding. Breast milk, when fed directly from the breast, provides immediately available nutrients with no wait and is at body temperature. Breast fed babies have a decreased risk for several infant conditions including Sudden Infant Death Syndrome (SIDS). The sucking technique required of the infant encourages the proper development of both the teeth and other speech organs. The many health benefits of breastfeeding have been well documented. Extensive research, especially in recent years, documents diverse and compelling advantages to infants, mothers, families, and society from breastfeeding and the use of human milk for infant feeding. These include health, nutritional, immunologic, developmental, psychological, social, economic, and environmental benefits.

It is not uncommon for a mother and child to have difficulties breastfeeding in the beginning, but most of these problems resolve in the early weeks.

A small percentage (between 2 & 3%) of women are unable to provide a full day's calories. Even among this small group, it is feasible to continue breastfeeding while supplementing with donated breast milk or artificial baby milk. Many of these mothers breastfeed exclusively by using thin tubing taped to the breast to deliver the supplementary food. This is called a supplementary nursing system, or SNS.

Since the nutritional requirements of the baby must be satisfied solely by the breast milk in breastfeeding, it is important for the mother to maintain a sufficient supply for the infants needs and supplement when necessary to promote proper growth and development of the infant. To determine the volume of milk consumed by a baby during breast-feeding sessions, it is known to weigh the baby before the session as well as during and immediately after the session. This is a cumbersome process and the scales required are rather sensitive and thus expensive.

### OBJECT OF THE INVENTION

An object of the present invention is therefore to solve the above discussed problems and to create an inexpensive device and method of measuring the quantity of milk breast fed to an infant without the use of scales.

### SUMMARY OF THE INVENTION

According to the invention there is provided an apparatus for determining the amount of human milk supplied to a feeding baby during a breast-feeding session. This apparatus includes a nipple shield adapted to be mounted on the nipple region of a breast of a mother; a tube or tubes defining an outlet through which milk passes to the feeding baby; and a thermal dilution gauge to measure the amount of milk passing through the outlet. The nipple shield may be nipple-shaped and may be made of silicon rubber or any other suitable material. Preferably, the tube may be made of stainless steel, rigid plastic, or any other suitable material for the transmission of a liquid.

The thermal dilution gauge may comprise a heater and two resistive temperature detectors (RTD), or only two RTD, which can be mounted outside or inside the tube(s), as separate components or as one chip. Electronic circuitry, a data communication cable, or electromagnetic transmitter, connecting the thermal dilution gauge to the CPU and/or display unit, may be mounted and/or integrated on the nipple shield.

The display means may comprise a liquid crystal or similar display, and/or may be adapted to print a graphical representation of the data received from the thermal dilution gauge.

The display means may comprise a number of switches for entering data (e.g. the age of the baby, etc.) or for selectively display of the amount of milk per session, the accumulating amount of milk in several sessions, and previously consumed milk (memory switch).

### BRIEF DESCRIPTION OF THE DRAWINGS

FIG. 1 is a diagrammatic illustration of the apparatus according to the invention connected to the breast of a breast-feeding mother;

FIG. 2 is a diagrammatic cross section of the nipple shield, illustrating the construction of the apparatus.

FIG. 3 is a view of the tube, partially cross-sectioned, mounted with a micro-machined thermal dilution gauge, according to the invention;

FIG. 4 is an isometric view of one of the suggested micro-machined thermal dilution gauges, according to the invention.

FIG. 5 is a diagram of two possible arrangements of the thermal dilution gauge, and its control circle.

FIG. 6 is a perspective view of the printed circuit board and connector which interface with the digital display unit.

FIG. 7 is a front view of the digital display device with attached connector.

### DETAILED DESCRIPTION OF THE INVENTION

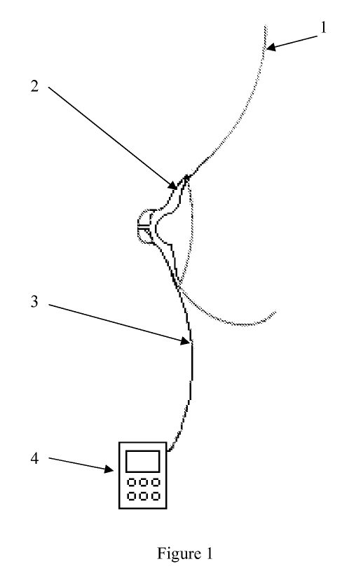

The invention will now further be described, by way of example only, with reference to the accompanying diagrams. The apparatus, in FIG. 1, for measuring the volume of human milk breast-fed to a baby comprises a nipple shield 2, a data communications cable 3 and a CPU and/or display unit 4. In use, the nipple shield 2 is mounted on the breast 1 of a mother. The feeding baby (not shown) is allowed to feed through the nipple shield 2.

The nipple shield 2 is made of three separate layers of silicon rubber 5, 6 and 8. Layer 8, as shown in FIG. 2, is a thickened part of layer 5 and they are both manufactured as one part during the molding process. Layer 8, which is thicker than the rest of the nipple shield, provides a cover for the tube 9. Layer 6 has holes 7 in it and is preferably attached to layer 5 by using medical-grade silicon rubber glue, in a way that forms a space (cavity) between layers 6 and 8.

The milk is allowed to flow through holes 7 in the inner layer 6 of the shield from several conduits in the mother's nipple. The milk is temporarily accumulated in the space between layers 6 and 8. There is only one tube 9 in the apparatus, through which the milk is delivered to the baby. The purpose of the cavity between layers 6 and 8 is to gather milk, running from several conduits in the mother's nipple, through the holes 7 and allow it to flow through the single tube 9. The driving force for the milk flow is the suction power of the baby. The volume of milk taken in by the baby is measured by the thermal dilution gauge 11.

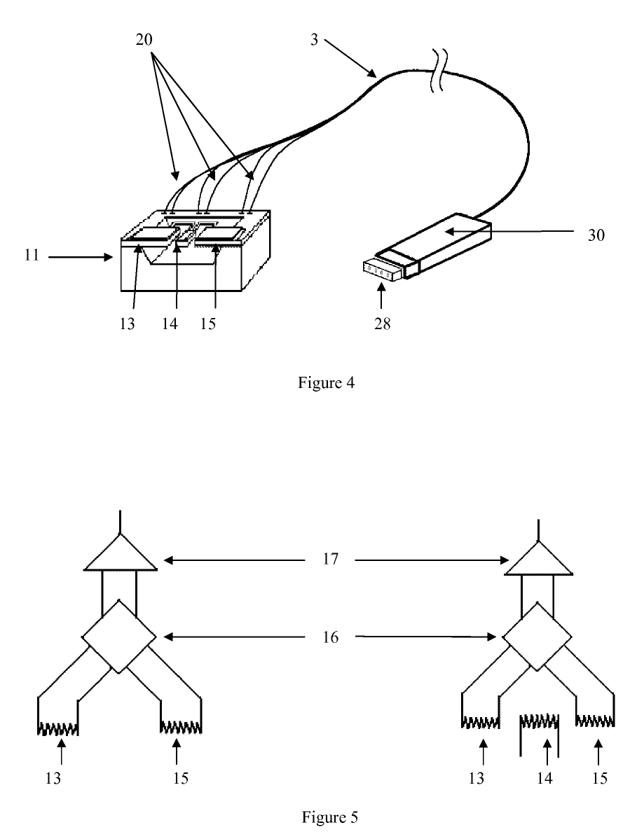

As shown in FIG. 5 there are two basic structures for the thermal dilution gauge 11, one with a heater 14 and two sensors 13, 15, and the second with only two sensors 13, 15. The sensors may be thermopiles or resistance temperature detectors (RTDs). The thermal dilution gauge 11 as shown on FIG. 4 may be a micro-machined chip, with the thermopiles or RTDs 13, 15 forming a part of it. Optionally, a heater 14 may be incorporated between the thermopiles or RTDs 13, 15. The thermal dilution gauge 11, as a micro-machined chip, has several soldering pads to which wires 20 in a data communications cable 3 are soldered.

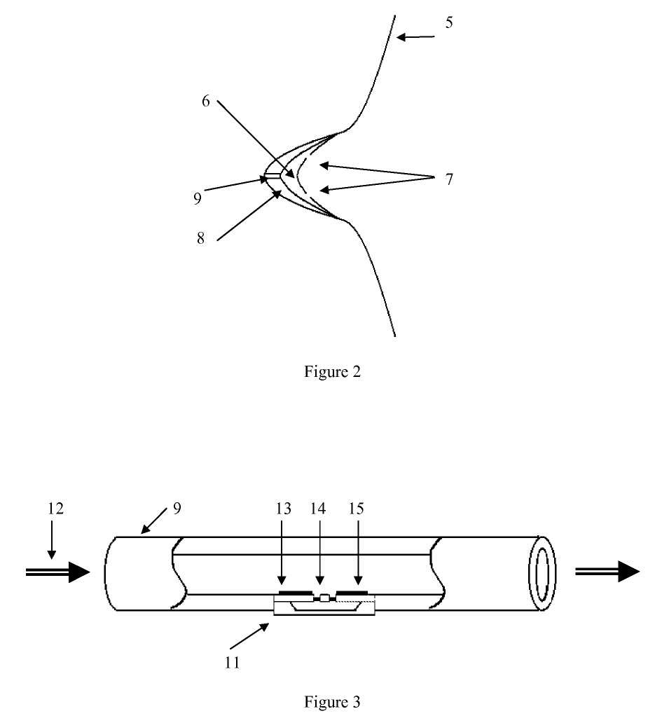

FIG. 3 shows the tube 9 with mounted thermal dilution gauge 11. All of the milk flow 12 passes through the precision manufactured tube 9 during nursing. The thermal dilution gauge 11 of FIG. 4 may be a micro-machined chip. The thermopiles or sensors 13, 15 form a part of thermal dilution gauge 11, and have several soldering pads to which wires 20 in a data communications cable 3 are soldered. Optionally, a heater 14 may be incorporated between the sensors 13, 15. The sensors 13, 15 with the soldered wires are assembled into the thermal dilution gauge 11, which is attached to the tube 9, in a special niche in the wall of the tube 9.

The tube 9 with thermal dilution gauge 11 is put inside a nipple shield mold, where the silicon rubber forming the nipple shield 2 is injected. The tube 9 is substantially perpendicular to the surface of the nipple shield 2.

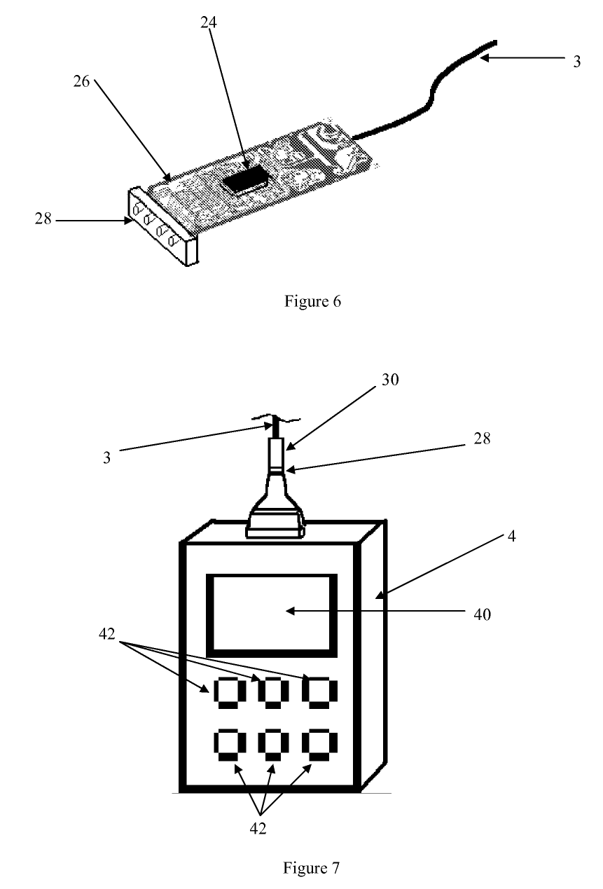

A small flexible PCB (printed circuit board) 26, as in FIG. 6, with an EPROM 24 and a connector 28 on it, are then soldered to the opposing end of the wires 20 in the communication cable 3. This flexible PCB 26 is then covered in a small flexible plastic housing. The housing 30 has an opening for the connector 28, to allow the user to connect the nipple shield 2 to the processing and display unit 4. The EPROM 24 (memory device) contains the specific calibration data of a particular tube/thermal dilution gauge of a particular nipple shield.

This EPROM 24 is used to store calibration data as each tube/thermal dilution gauge is different and must be individually calibrated. Using a calibration process, a table or an equation is generated which represents the specific signal that corresponds to the specific flow rate. This table is memorized in the EPROM 24. These calibrations take into account minor variations in the size of the tube 9 and the distance apart of the sensors 13, 15, as well as the optional heater 14.

FIG. 7 shows the display 40 as a part of the processing CPU and display unit 4 which is separately connectable by connector 28 to any individual nipple shield 2. The processing and display unit 4 includes another PCB with electronic components, a microprocessor and an LCD as the display 40, all contained within a plastic housing. Additionally, there are a series of selectable buttons 42 for control and selection on the display unit 4.

The microprocessor in the processing unit 4 samples the signal from the measuring unit many times per second. The microprocessor uses these samples and the calibration data in the EPROM 24 to convert the signal to flow data. The flow data is then integrated over time to give the accumulating amount of milk. This amount is then shown on the LCD display 40.

As shown in FIG. 5 there are two basic structures for the thermal dilution gauge 11, one with a heater 14 and two sensors 13, 15, and the second with only two sensors 13, 15. In these two arrangements, the breast milk 12 flows in the tube 9 and over the surface of the thermal dilution gauge 11. The flow of the breast milk 12 is such that it would first pass over the upstream thermopile or sensor 13 then over the heater 14, if it exists, and then over the downstream thermopile or sensor 15. The measuring principle for each structure is now described.

In a device with a heater plus two thermopiles, the heater 14 is heated to 2-3 degrees Celsius, above the expected temperature of the liquid (˜36 degrees C.). When there is no flow, the two sensors 13, 15, sitting at the same distance from each side of the heater 14, will register the same temperature. When there is a flow 12, the temperature registered by the upstream thermopile 13 will be lower than the temperature registered by the downstream sensor 15. The two sensors 13, 15 are connected through an electronic bridge 16. The different temperatures registered by the sensors 13, 15 will make the bridge 16 generate an analog signal. This analog signal represents the voltage difference between the two sensors. The signal increases as the flow 12 increases. The signal is the amplified using an amplifier 17 for reading by the display unit 4.

In a device with only two thermopiles and no separate heater, the two thermopiles 13, 15 also serve as heaters and are constantly heated to 2-3 degrees C., above the expected temperature of the liquid (˜36 degrees C.). When there is no flow 12, there is no temperature difference between the two thermopiles 13, 15. When there is a flow 12, the temperature of the down stream thermopile 15 will be higher than the temperature of the upstream 13 thermopile. This is due to the fluid being heated slightly by the upstream thermopile 13 before reaching the downstream thermopile 15. The two thermopiles are connected through an electronic bridge 16. The different temperatures registered will make the bridge 16 generate an analog signal, which represents the voltage difference between the two sensors. This analog signal will increase as the flow 12 increases. This signal is amplified using an amplifier 17 for reading by the display unit 4.

In both arrangements, since the temperature difference between the two detectors is directly proportional to the mass flow of the milk, a highly accurate and repeatable flow measurement is obtained.

Thus, the apparatus according to the invention provides the nursing mother in real time with an indication of the volume of milk taken in by a feeding baby. It would accordingly no longer be necessary to follow the cumbersome weighing process hereinbefore described.

The invention is described in detail with reference to a particular embodiment, but it should be understood that various other modifications can be effected and still be within the spirit and scope of the invention.

1. An apparatus for determining the amount of milk supplied to a baby during breast: feeding comprising: a nipple shield mounted on a nipple region of a breast of a mother; a tube connected to said nipple shield and through which milk passes from the mother to the baby; a first detector sensing the flow temperature of the milk; a second detector sensing the flow temperature of the milk and located downstream of said first detector; means for calculating the difference between the temperatures sensed by said first and second detectors and then calculating the flow rate based on the temperature difference being proportional to the flow rate; a display for displaying the flow rate.

2. An apparatus according to claim 1, further comprising a heater positioned between said first and second detectors and said heater heating the milk flow.

3. An apparatus according to claim 1, wherein said means for calculating includes a Wheatstone bridge and an amplifier.

4. An apparatus according to claim 2, wherein said means for calculating includes a Wheatstone bridge and an amplifier.

5. An apparatus according to claim 1, wherein said nipple shield in made of multiple layers of silicon rubber.

6. An apparatus according to claim 2, wherein said nipple shield in made of multiple layers of silicon rubber.

7. An apparatus according to claim 3, wherein said nipple shield in made of multiple layers of silicon rubber.

8. An apparatus according to claim 4, wherein said nipple shield in made of multiple layers of silicon rubber.
